(19) United States
(12) Patent Application Publication
(10) Pub. No.: US 2011/0253279 A1
(43) Pub. Date: Oct. 20, 2011

(54) TYRE REINFORCED WITH STEEL CORDS COMPRISING FINE FILAMENTS

(76) Inventors: Guido Luigi Daghini, Milano (IT); Marco Cipparrone, Milano (IT); Marcio Massami Takimoto, San Paolo (BR)

(21) Appl. No.: 13/141,195

(22) PCT Filed: Dec. 12, 2008
(86) PCT No.: PCT/IT08/00785

§ 371 Date: Jun. 21, 2011

(51) Int. Cl. B60C 9/18; B32B 27/04; B60C 9/16

(52) U.S. Cl. 152/526; 152/556; 152/531; 428/297.4

(57) ABSTRACT

A tyre includes a carcass structure including at least one carcass ply and a belt structure including at least one belt layer. The carcass ply includes a plurality of metallic cords. Each of the metallic cords includes a plurality of strands. Each strand of the plurality of strands includes a plurality of filaments having a diameter between 0.06 and 0.15 mm. The strands are disposed so as to form a cord structure having a cross section in which a substantially circular layer of outer strands is disposed around a central strand.

### FIELD OF THE INVENTION

The present invention relates to a tyre, particularly a tyre for medium and/or light trucks. More particularly, the present invention relates to a tyre reinforced with cords comprising fine steel filaments.

### BACKGROUND OF THE INVENTION

Conventional pneumatic radial tyres for trucks typically use steel cords as reinforcement both in their carcass and belt structures. The steel cords are fatigued by being subjected to repeated deformation during the running of the tyre, which causes repeated strain and fretting wear in contact portions between filaments. Moreover, corrosion due to water penetrating from the outside of the tyre may cause additional degradation of the cord properties.

An example of a steel cord used in tyres for use with trucks includes a two-layer or three-layer steel cord which comprises an inner layer consisting of a plurality of twisted filaments, and one or more outer layers comprising of a plurality of twisted filaments disposed around the inner layer. For example, a conventional two-layer steel cord used in truck tyres consists of three filaments twisted together in an inner layer, surrounded by nine filaments disposed in an, outer layer: such cord is conventionally identified as a “3+9” cord.

Penetration of rubber can be effective for enhancing the corrosion fatigue properties of the cord, and also the fretting wear between filaments. However, in case of multi-layer structure cords, such as a two or three layer structure cord as used in the carcass ply or belt layer for truck tyres, it is very difficult to completely penetrate rubber into the inner layer of the cord.

Among the steel cords proposed for use in tyres, there are cords comprising fine steel filaments.

For example, European Patent Application EP 1547816 discloses a steel cord for reinforcing a tyre carcass of a radial tyre for a passenger car, which has a 1+n structure including a plurality of ultrafine steel filaments with a diameter of 0.14 mm or less stranded with each other, and which is embedded in a topping sheet according to a predetermined pattern. Additionally, the diameter of the sheath filaments is adjusted to be smaller than the core filament to enable rubber to come into contact with the steel cord and simultaneously suppressing a fretting phenomenon, thereby improving fatigue resistance and durability of the radial tyre for high speed driving without reducing strength of the radial tyre in comparison with conventional radial tyres using synthetic fiber cords in the carcass.

European Patent Application EP 987128 discloses a pneumatic tyre with a carcass having parallel cords, where each cord comprises multiple filaments having a diameter (D) ranging from 0.07 mm to 0.45 mm, and each filament has at least a tensile strength of −2000×D+4400 MPa (Ultra Tensile, or UT, Steel). For replacement of a 1840/2 rayon single ply in a radial passenger or light truck tyre, this patent application suggests, among other examples, plies including a 3+8×0.10 cord, a 1×0.10+(6+12)×0.09 cord, a 2+7×0.15 cord.

Japanese Patent Application JP 58-221703 discloses a radial carcass ply made up such that three strands each of which is a twisted bundle of three metal wires having a diameter between 0.08 and 0.15 mm are twisted into a metal cord which exhibits an elongation of 2% or more when broken, and the metal cord is coated with rubber.

### SUMMARY OF THE INVENTION

A carcass of a truck tyre should be able to last a substantial number of traveled kilometers, typically at least two or even three times the duration of the tread band of the same tyre. Normally, truck tyres are subjected to re-treading, i.e. to the application of a new tread band on an aged carcass. To be properly re-treaded, a carcass should not have areas subjected to corrosion. Moreover, the carcass should guarantee fatigue resistance for the whole life of the tyre, even after two or three re-treading applications.

The Applicant has faced the problem of providing tyre carcasses being able to resist to fatigue and corrosion even after a substantial number of traveled kilometers of the tyres, and being able to sustain re-treading, preferably more than twice.

The Applicant has found that lasting fatigue resistance properties together with excellent rubber penetration capability and corrosion resistance can be obtained by using, in the tyre carcasses, metallic cords made of a plurality of strands of fine filaments having diameter comprised between 0.06 and 0.15 mm, in which the plurality of strands are disposed so as to obtain an almost regular cross section, in which a plurality of outer strands is disposed so as to form a substantially circular layer around a central strand.

It has also been found that rubberized layers made with such metallic cords are able to provide the above mentioned improved fatigue and corrosion resistance properties together with remarkably reduced weight and stiffness. The whole of the above mentioned improved properties make such rubberized layer particularly suited for the carcass of medium and light truck tyres.

In preferred embodiments, the metallic cords comprise seven strands of filaments.

In preferred embodiments, the filaments in all the strands are twisted, respectively in each strand, according to the same twisting orientation, equal to the twisting orientation of the strands to form the cord. It has been found that such cords provide a better resistance to fatigue. According to the Applicant, this may be due to the fact that the filaments and/or the strands contact with each other in elongated portions, so as to still reduce the fretting phenomenon.

According to a first aspect, the invention relates to a tyre comprising a carcass structure comprising at least one carcass ply and a belt structure comprising at least one belt layer, said at least one carcass ply comprising a plurality of metallic cords, wherein each of said metallic cords comprises a plurality of strands, wherein each strand of the plurality of strands comprises a plurality of filaments having a diameter comprised between 0.06 and 0.15 mm, and wherein the plurality of strands are disposed so as to form a structure having a cross section in which a substantially circular layer of outer strands is disposed around a central strand.

Said tyre is particularly suited for medium and/or light trucks. Typically, the size of these tyres is such that they are adapted to be fitted on rims having a diameter of less than 20″.

According to a second aspect, the invention relates to a rubberized layer comprising a plurality of strands twisted according to a twisting orientation, wherein each strand of the plurality of strands comprises a plurality of filaments having a diameter comprised between 0.06 and 0.15 mm twisted according to said twisting orientation, and wherein the plurality of strands are disposed so as to form a structure having a cross section in which a substantially circular layer of outer strands is disposed around a central strand.

According to a third aspect, the invention relates to a metallic cord comprising a plurality of strands twisted according to a twisting orientation, wherein each strand of the plurality of strands comprises a plurality of filaments having a diameter comprised between 0.06 and 0.15 mm twisted according to said twisting orientation, and wherein the plurality of strands are disposed so as to form a structure having a cross section in which a substantially circular layer of outer strands is disposed around a central strand.

The present invention, in at least one of the abovementioned aspects, may show one or more of the preferred characteristics hereinafter disclosed.

The tyre may be a radial tyre. In such case, said metallic cords in said at least one carcass ply are disposed substantially orthogonally to a circumferential direction of the tyre.

Typically, said belt structure comprises at least two radially superimposed main belt layers. Each of said at least two main belt layers comprises a second plurality of metallic cords disposed in a crossed orientation with respect to a circumferential direction of the tyre. The metallic cords of a radially inner main belt layer are crossed with respect to the metallic cords of a radially outer main belt layer.

Said belt structure may also comprise a radially outermost belt layer comprising a third plurality of metallic cords disposed in a crossed orientation with respect to the circumferential direction of the tyre. Such radially outermost belt layer is advantageously provided in order to counteract stone or gravel penetration towards the radially inner layers of the belt and/or of the carcass structure.

In preferred embodiments, said belt structure comprises at least one zero degree layer comprising a fourth plurality of metallic cords disposed substantially at a null angle with respect to the circumferential direction of the tyre (e.g., at an angle comprised between 0° and)5°).

Said at least one zero degree layer may be radially superimposed to the radially outer main belt layer. In more preferred embodiments, said at least one zero degree layer comprises two strips located in axially external positions of said belt structure.

Each of the metallic cords of the at least one carcass layer may have a structure comprising a central strand surrounded by six strands.

In preferred embodiments, a twisting pitch in the central strand is greater than a twisting pitch in the outer strands surrounding the central strand. It has been found that this choice increases the probability of maintaining a regular structure of the cord (i.e. an almost regular, symmetric, cross section of the cord) along its length during manufacturing.

Each strand forming the cord may comprise three to seven filaments, preferably three to five filaments.

The strands forming the cord may all comprise the same number of filaments.

In preferred embodiments, at least one of said strands comprises at least one filament having a diameter greater than the diameter of the remaining filaments.

Using filaments of greater diameter further increases penetration of rubber towards the central strand of the cord. Moreover, this may also increase the stiffness of the cord and/or of the rubberized layer.

In one exemplary embodiment, the diameter of the filaments of the central strand is greater than the diameter of the filaments of the strands surrounding said central strand.

A wrapping filament can be wound around the cord. The diameter of the wrapping filament can be preferably the same as the diameter of at least some of the filaments making the strands.

A thickness of the above mentioned rubberized layer may be preferably comprised between 1.2 mm and 2.5 mm. A density of said plurality of metallic cords in said layer may be preferably comprised between 50 cords/dm and 120 cords/dm. The plurality of metallic cords can be embedded in the rubber compound to form the layer so as to alternate with portions comprising only rubber compound having substantially the same width preferably comprised between 0.15 mm and 1.4 mm.

A rubberized layer sized according to the above is particularly suited for a carcass ply of tyres, more particularly of medium and/or light truck tyres.

### BRIEF DESCRIPTION OF THE DRAWINGS

Further features and advantages of the present invention will be made apparent by the following detailed description of exemplary embodiments thereof, provided merely by way of non-limitative examples. The description will make reference to the attached drawings, wherein:

FIGS. 1a, 1b, 1c schematically show exemplary embodiments of truck tyres;

FIGS. 2a, 2b, 2c schematically show exemplary embodiments of a metallic cord comprising seven strands of fine steel filaments twisted together (in cross section);

FIG. 3 shows a load-elongation curve of an exemplary metallic cord such as the one disclosed in FIG. 2a, compared with the load-elongation curve of a conventional 3+9 cord;

FIG. 4 schematically shows a rubberized layer comprising metallic cords;

FIG. 5 shows a result of an outdoor test performed on exemplary tyres according to the invention and on comparative exemplary tyres.

### DETAILED DESCRIPTION OF THE INVENTION

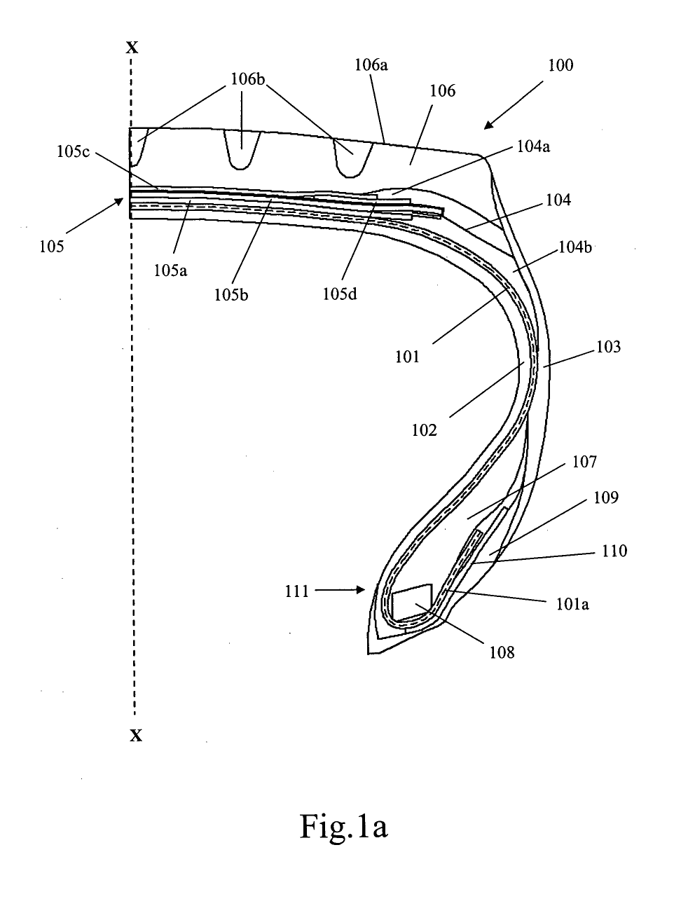

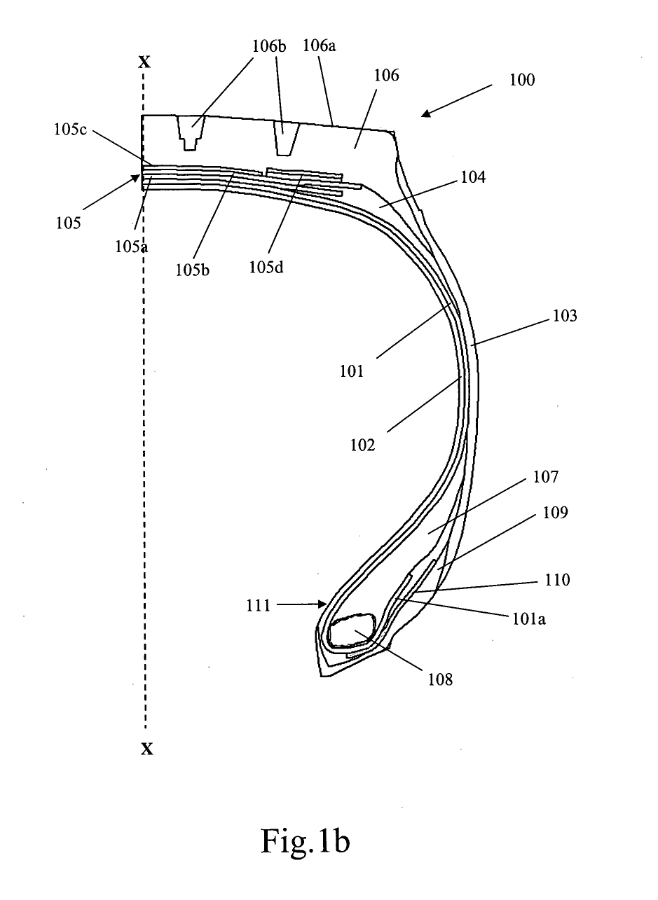

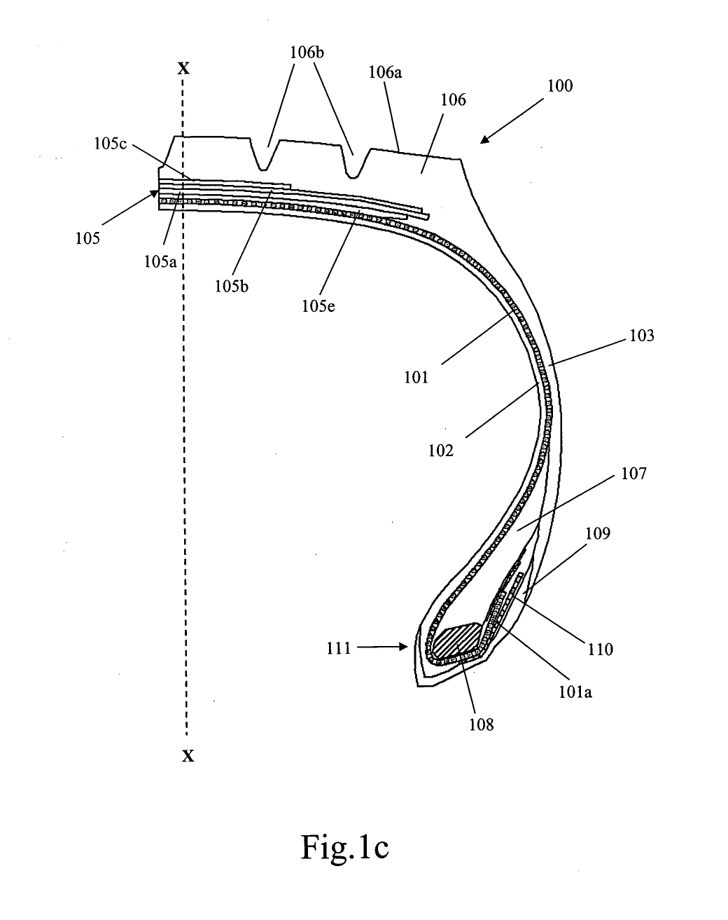

FIGS. 1a, 1b, 1c show exemplary embodiments of tyres suitable for medium and/or light trucks. Typically, such tyres have a size adapted to be fitted to rims having diameter lower than 20″ (for example 215/75 R17.5, 285/70 R19.5). For simplicity, FIGS. 1a, 1b, 1c show only a portion of the tyre, the remaining portion not represented being identical and symmetrically arranged with respect to the equatorial plane (X-X) of the tyre. The same reference numbers identify, in each of FIGS. 1a, 1b, 1c, corresponding structural elements of the tyres.

The tyre (100) comprises a carcass structure having at least one carcass ply (101), the opposite lateral edges of which are associated with respective bead structures (111) comprising at least one bead core (108) and at least one bead filler (107). The association between said carcass ply (101) and said bead structure (111) can be achieved by turning back the opposite lateral edges of said carcass ply (101) around said bead core (108) and said bead filler (107) so as to form the so-called carcass turn-up (101a), as shown in the figures.

The carcass ply (101) typically comprises a plurality of reinforcing elements arranged parallel to each other embedded in a layer of a crosslinked elastomeric material. In truck tyres, these reinforcing elements are usually made of metal cords, preferably steel cords, stranded together. In the tyres of the invention, the carcass ply (101) comprises metal cords made by a number of strands comprising filaments having a diameter comprised between 0.06 and 0.15 mm, and wherein each of said strands comprises a plurality of said filaments.

The carcass ply (101) is usually of radial type, i.e. it incorporates reinforcing elements arranged in a substantially perpendicular direction relative to a circumferential direction.

The bead core (108) is enclosed in a bead structure (111), defined along an inner circumferential edge of the tire (100), with which the tyre engages on a rim (not shown in the figures) forming part of a vehicle wheel. The space defined by each carcass turn-up (101a) contains a bead filler (107) usually made of a crosslinked elastomeric material. In preferred embodiments, the bead core (108) comprises a plurality of windings of a metallic (e.g. steel) elongated element substantially having a hexagonal cross sectional shape.

An antiabrasive strip (109) is usually applied in an axially outer position with respect to the carcass turn-up (101a).

A reinforcing layer (110), also known as a “chafer”, is applied in an axially outer position with respect to the carcass turn-up (101a). At least a portion of the chafer (110) can be wound around the bead core (108) and the bead filler (107) so as to at least partially envelope them. Said chafer (110) typically comprises a plurality of metal cords, which are embedded in a layer of a crosslinked elastomeric material.

Preferably, the reinforcing cords of said chafer (110) are disposed parallel to one another and are inclined, with respect to the reinforcing elements of said carcass ply (101), with an inclination angle of from about 10° to about 45°, preferably of from about 15° to about 35°.

Alternatively or in combination, a reinforcing layer can be disposed along the axially inner portion of the carcass ply (101) in the bead region (not shown in the figures).

A belt structure (105) is applied along a crown portion of the carcass ply (101), in a radially outer position thereof. The belt structure (105) typically comprises two main belt layers (105a) and (105b) which are radially superimposed and which incorporate a plurality of reinforcing elements, typically metal cords. Said reinforcing elements are parallel to each other in each layer and crossed with respect to the reinforcing elements of the adjacent layer, and are inclined preferably in a symmetrical manner with respect to a circumferential direction of the tyre, at an angle of from 10° to 70°, preferably of from 12° to 40°. The reinforcing elements are typically coated with a crosslinked elastomeric material.

Preferably, said reinforcing elements have a density of from 30 cords/dm to 80 cords/dm, preferably of from 40 cords/dm to 65 cords/dm, measured on said two main belt layers (105a) and (105b), in a circumferential direction, close to the equatorial plane (X-X) of the tyre (100).

Moreover, the belt structure (105) can further comprise a third belt layer (105c) applied as radially outermost layer of the belt structure (105), provided with reinforcing elements, typically metal cords. Said reinforcing elements are arranged parallel to one another, and are inclined with respect to a circumferential direction of the tyre by an angle of from 10° to 60°, preferably of from 12° to 40°. The reinforcing elements are typically coated with a crosslinked elastomeric material. Said third belt layer (105c) acts as a protection layer against penetration of stones or gravel possibly entrapped into the tread grooves (106b), which may cause damages to the inner belt layers, and even to the carcass ply (101).

Preferably, said reinforcing elements of the third belt layer (105c) have a density of from 30 cords/dm to 80 cords/dm, preferably of from 35 cords/dm to 65 cords/dm, measured on said third belt layer (105c), in a circumferential direction, close to the equatorial plane (X-X) of the tyre (100).

Furthermore, in the embodiments shown in figures 1a, 1b, the belt structure (105) comprises a lateral reinforcing strip (105d), referred to as “zero-degree reinforcing strip”, applied in a radially outer position with respect to the second main belt layer (105b). Said reinforcing strip (105d) generally incorporates a plurality of reinforcing elements, typically metal cords. Differently from the other layers of the belt structure, the reinforcing elements of the zero-degree reinforcing strip are oriented in a substantially circumferential direction (e.g., forming an angle of from 0° to 5° with respect to a circumferential direction of the tyre). The reinforcing elements are typically coated with a crosslinked elastomeric material.

More particularly, in the embodiment shown in FIG. 1a, the zero-degree reinforcing strip (105d) is realized by spiral winding a rubberized tape having a width lower than the strip (105d) itself around the second main belt layer (105b), in an axially outer portion thereof. The tape embeds few metal cords (e.g. two-three metal cords). A plurality of axially side-by-side disposed windings thus forms the zero-degree strip (105d) in this embodiment.

Alternatively, in the embodiment shown in FIG. 1b, the zero degree reinforcing strip (105d) is realized by radial superposition of two-three windings of a strip of predetermined width, comprising the reinforcing elements.

In the embodiments of FIGS. 1a, 1b, an insert (104) is positioned at the buttress area, i.e. the area where the lateral edges of the tread band (106) is connected to the sidewall (103). Usually, the insert (104) is interposed between the carcass ply (101), the belt structure (105), the tread band (106) and the sidewall (103).

In more detail, the insert (104) comprises an axially inner portion (104a) which is interposed between the belt structure (105) and the tread band (106) and is tapered towards the equatorial plane (x-x) of the tire, and an axially outer portion (104b) which is interposed between the carcass ply (101) and the correspondent sidewall (103) and is tapered towards the rotational axis of the tire.

In the embodiment of FIG. 1c, the belt structure (105) comprises a further layer (105e) applied as radially innermost layer of the belt structure (105), provided with reinforcing elements, typically metal cords. Said reinforcing elements are arranged parallel to one another, and are inclined with respect to the equatorial plane (X-X). Typically, the inclination angle of the metallic cords in the innermost layer (105e) is greater than 45°. The cords are coated with a crosslinked elastomeric material.

A tread band (106), whose lateral edges are connected to the sidewall (103), is applied circumferentially in a radially outer position with respect to the belt structure (105). Externally, the tread band (106) has a rolling surface (106a) designed to come into contact with the ground. Circumferential grooves (106b) and/or transverse grooves (not represented in FIG. 1) define a tread pattern which may comprise a plurality of ribs and/or blocks of various shapes and sizes distributed over the rolling surface (106a) of the tread band surface (106a).

A sidewall (103) is applied externally onto the carcass ply (101), this sidewall extending, in an axially outer position, generally from the bead structure (111) to the tread band (106).

In the case of tubeless tires, a rubber layer (102) generally known as a liner, which provides the necessary impermeability to the inflation air of the tire, is also typically provided in an inner position relative to the carcass ply (101).

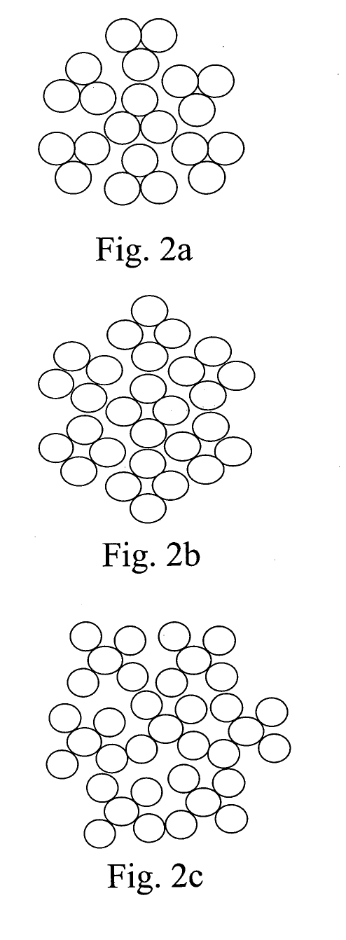

FIGS. 2a, 2b, 2c schematically show cross sections of exemplary embodiments of the metallic cords used in the carcass ply or plies (101) of the tyres (100) of the invention.

The metallic cords of FIGS. 2a, 2b, 2c comprise seven strands of fine metallic filaments having a diameter comprised between 0.06 and 0.15 mm. The seven strands are twisted together to form the cord. In particular, the twisting is performed so as to leave a central strand surrounded by six outer strands. Each strand comprises filaments twisted together with a first twisting pitch. The various strands are then twisted with a second twisting pitch.

In preferred embodiments, the twisting pitch of the filaments comprised in the central strand is greater than a twisting pitch of the filaments comprised in the six strands surrounding the central strand. Moreover, in preferred embodiments the second twisting pitch (i.e. the twisting pitch of the cord) is greater than the twisting pitch in the six strands surrounding the central strands. In more preferred embodiments, the twisting pitch in the central strand is substantially equal to the second twisting pitch. A preferred range for the first and/or for the second twisting pitch is between 3 and 20 mm.

The fine filaments of the various strands are twisted according to a twisting orientation (e.g. S direction). To form said metallic cord, the strands are preferably twisted according to same twisting orientation.

The fine filaments are typically made of steel (NT, HT, SHT or UHT steel), and are typically coated with brass or another corrosion resistant coating (e.g. a Zn/Mn coating). An additional brass (or other corrosion resistant) coating step could be also performed to the cord, after the twisting of the various strands.

As a first example, FIG. 2a shows a 7×3 cord structure, in which three fine filaments are twisted in strands at a first twisting pitch (which may be different in different strands). Then seven strands are twisted together at a second twisting pitch to form the cord.

As a second example, FIG. 2b shows a 7×4 cord structure, in which four fine filaments are twisted in strands at a first twisting pitch (which may be different in different strands). Then seven strands are twisted together at a second twisting pitch to form the cord.

As a third example, FIG. 2c shows a 7×5 cord structure, in which five fine filaments are twisted in strands at a first twisting pitch (which may be different in different strands). Then seven strands are twisted together at a second twisting pitch to form the cord.

As visible from FIGS. 2a, 2b, 2c, the outer strands completely enclose the central strand to form a regular cord structure, almost circular when considering its cross section. However, spaces are formed between the outer strands, to allow penetration of rubber from the outer strands to the central strands.

In order to increase penetration of rubber towards the central strand of the cord, and/or stiffness of the cord, at least one of the strands may comprise at least one filament having a diameter greater than the diameter of the remaining filaments. Preferably, a difference in diameter of the filaments may be of at least 0.01 mm, more preferably of at least 0.015 mm. For example, the diameter of the filaments of the central strand can be greater than the diameter of the filaments of the strands surrounding the central strand. As another example, the diameter of at least one of the filaments in the outer strands can be greater than the diameter of the remaining filaments, and, particularly, of the filaments of the central strand. As a further example, in the metallic cord of FIG. 2c, the central filament of each strand can have a greater diameter than the diameter of the other filaments.

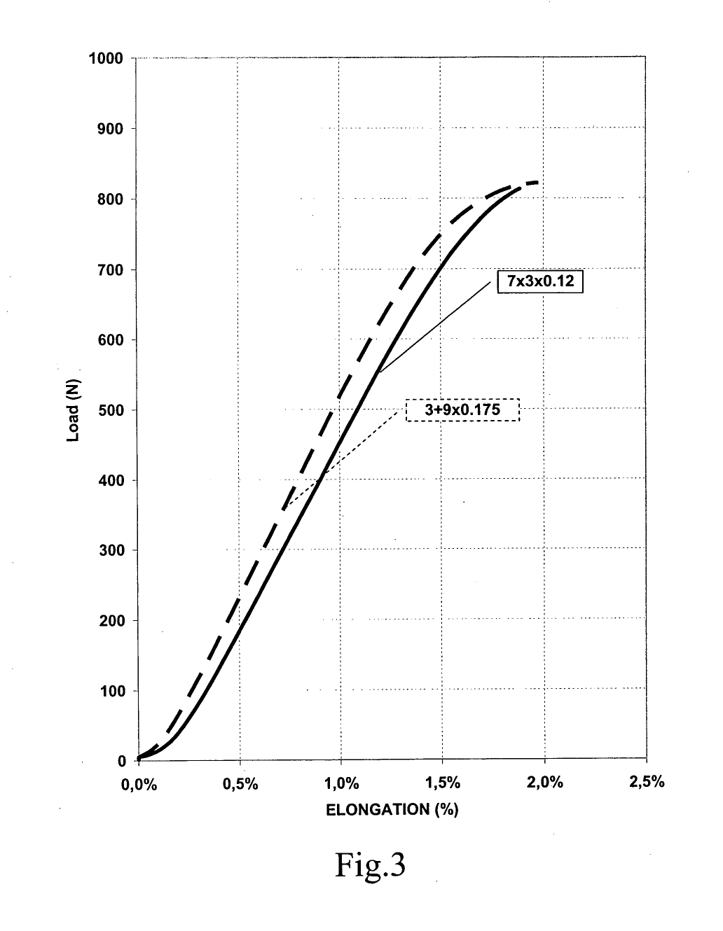

The properties of the cord made of fine filaments can be tuned to match corresponding properties of conventional cords used in the carcass plies of medium and/or light truck tyres. FIG. 3 schematically shows the load-elongation diagram of an exemplary 7×3×0.12 LL steel cord as compared with the corresponding curve of a conventional 3+9×0.175+0.15 steel cord. As it can be seen, the two curves substantially match with each other.

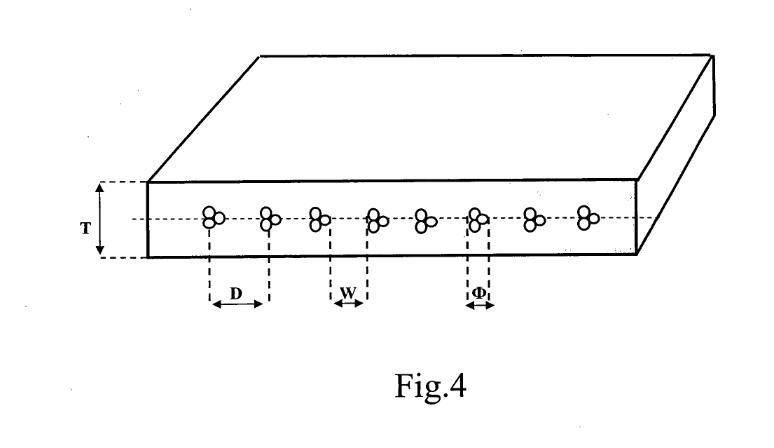

FIG. 4 schematically shows a sectional view of a rubberized layer, for example for a carcass ply, including the cords above described. The rubberized layer could be produced by conventional methods, e.g. by coupling a plurality of cords with rubber in a calendering apparatus. The cords included in the rubberized layer are disposed substantially parallel to each other. Parameters characterizing the layer may include a density of the cords (typically expressed in cords/dm) and a thickness T of the layer. Other parameters shown in FIG. 4 are the average diameter φ of the cords, the centre-to-centre distance D between the cords (i.e. the inverse of the cord density), the width W of the portions of the layer located between the cords and comprising only rubber compound.

### Example 1

An exemplary “7×3” cord, as that shown in FIG. 2a, was prepared, having the features reported in Table 1.

TABLE 1

| | |
|---|---|
| Filament diameter | 0.12 mm |
| Twisting pitch of the filaments | 12.5 mm |
| in the central strand | |
| Twisting pitch of the filaments | 8 mm |
| in the outer strands | |
| Twisting pitch of the strands | 12.5 mm |
| to form the cord | |
| Twisting direction of the | S |
| filaments in the strands | |
| Twisting direction of the | S |
| strands in the cord | |
| Steel | NT |
| Filament Coating | Brass |

A comparison cord, having a “3+9” structure with the features of Table 2, was also prepared.

TABLE 2

| | |
|---|---|
| Filament diameter | 0.175 mm |
| Twisting pitch of the central filaments | 5 mm |
| Twisting pitch of the outer filaments | 10 mm |
| | (+5 mm wrapping wire) |
| Twisting direction of the central filaments | S |
| Twisting direction of the outer filaments | S |
| | (+Z wrapping wire) |
| Steel | NT |
| Filament Coating | Brass |

Table 3 reports the results of some tests performed on the two cords. In particular, the stiffness, the rubber penetration capability and the resistance to fatigue of the cords were evaluated. For the stiffness and the rubber penetration capability, the features of the 3+9×0.175 cords were taken as reference, and thus they are reported with reference number “100”.

In particular, the stiffness of the cords was evaluated by using the BISFA E8 standard method (Taber stiffness).

The rubber penetration capability was evaluated by measuring the content of air entrapped in vulcanized specimens extracted from a rubberized layer comprising the cords under test. The air content was measured by collecting the air bubbles exiting from the specimens after their immersion in ethyl alcohol.

The resistance to fatigue was measured by the Wallace Test, in which vulcanized strips of rubberized layer comprising the cords under test were subjected to a series of cyclical flexing movements caused by moving alternatively the strip in opposite directions about a roller of predefined dimensions, using a predefined load. Table 3 reports the number of cycles which cause breakage of the strip sample

TABLE 3

| | 3 + 9 × 0.175 * | 7 × 3 × 0.12 |
|---|---|---|
| Stiffness | 100 | 39 |
| Content of entrapped air | 100 | 28-30 |
| Resistance to fatigue-Wallace Test | 6000 | >10000 |
| (number of cycles) | | |

(* comparison)

As it can be seen from the data reported in Table 3, the 7×3'0.12 cord shows a significantly lower stiffness and a greatly improved rubber penetration capability. The latter result is particularly significant with respect to the resistance to corrosion that the cord can offer. Moreover, the Wallace Test was interrupted after 10000 cycles without ruptures in the tested samples. It has also to be noticed that the cords extracted from the samples after the Wallace Test still had a residual breaking strength of about 85% of the breaking strength of the new cord.

### Example 2

Two rubberized layers were prepared comprising the 3+9×0.175 and the 7×3×0.12 cords disclosed with reference to example 1, having a cord density of 80 cords/dm.

Table 4 shows the other properties of the two rubberized layers.

TABLE 4

| | 3 + 9 × 0.175 * | 7 × 3 × 0.12 |
|---|---|---|
| Average cord diameter (mm) | 0.96 ± 0.05 | 0.68 ± 0.05 |
| Width of only rubber | 0.29 ± 0.05 | 0.57 ± 0.05 |
| portions between cords (mm) | | |
| % steel (average diam × cord density) | 77 | 54 |
| Layer breaking strength (N * dm) | 65600 | 64800 |
| Weight (g/m²) | 3850 | 3490 |

(* comparison)

The above results show that the cord comprising strands of fine steel filaments allows the manufacture of rubberized layers reaching substantially comparable breaking strength of rubberized layers reinforced with conventional 3+9 cords. Remarkably, this result is obtained with an increased width and thickness of the only rubber compound portions located between the cords and embedding the cords, which provides a better distribution of the stresses transmitted from the cords to the compound, with a lower fatigue of the latter. It has also to be noticed that such results are obtained with remarkably reduced stiffness and weight of the rubberized layer, with a further advantage for use in medium and/or light truck tyres.

### Example 3

A series of tyres of size 215/75 R17.5 having a carcass comprising 7×3×0.12 cords with the features reported in the above Table 1 was manufactured and subjected to an outdoor test. One series of comparative tyres of the same size were also subjected to an outdoor test: the comparative series had a carcass comprising 3+9 cords.

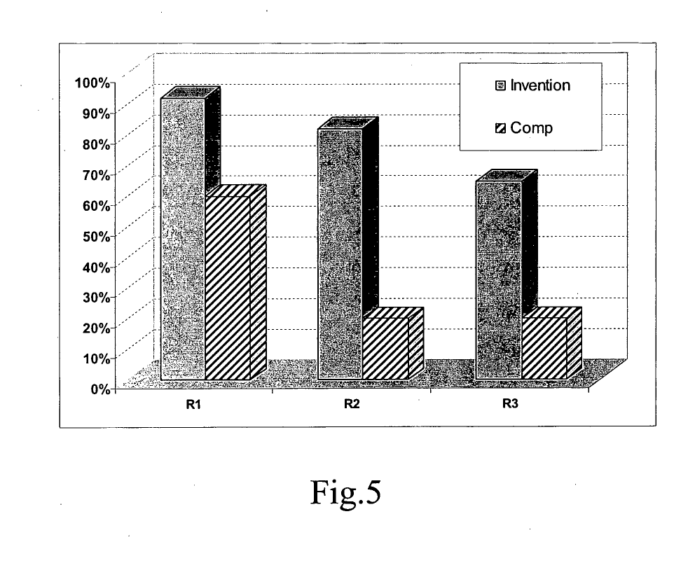

FIG. 5 shows a result of the outdoor tests. In particular, FIG. 5 shows the percentage of tyres which could be re-treaded once (R1), twice (R2) and thrice (R3), respectively for the tyres of the invention (INV), and for the tyres of the comparative series (COMP).

As it can be seen, the percentage of tyres which could be re-treaded was always better for the tyres of the invention. Such difference was particularly significant for multiple re-treading: while about 80% of the tyres of the invention could be re-treaded twice, and more than 60% of the tyres of the invention could be re-treaded thrice, the comparative tyres were not able to support multiple re-treading in a significant portion.

Moreover, after the third re-treading the tyres of the invention were analyzed in order to verify the status of the tyre structure.

No substantial defects were detected by X-ray analysis and sheargraphy. Moreover, after removal of the residual tread band, no practical variations with respect to new tyres were optically observed in the basic parameters (density, geometry, deposition angles) of the cords of the belt structure, so that it can be assumed that the underlying carcass did not cause any significant degradation of the operating working points of the belt structure itself during the long-lasting life of the tyres. Similar results were also observed for the cords of the carcass structure in the bead portion, after removal of the sidewall rubber. Furthermore, no remarkable corrosion phenomena or air bubble formation were detected within the carcass.

In addition, a further analysis performed on the 7×3×0.12 cords extracted from the tyres after the third re-treading did not show any significant degradation of the cord filaments due to fretting.

1-20. (canceled)

21. A tyre comprising a carcass structure comprising at least one carcass ply and a belt structure comprising at least one belt layer, said at least one carcass ply comprising a plurality of metalic cords, wherein each of said metalic cords comprises a plurality of strands, wherein each strand of the plurality of strands comprises a plurality of filaments having a diameter between 0.06 and 0.15 mm, and wherein the plurality of strands is disposed so as to form a cord structure having a cross section in which a substantially circular layer of outer strands is disposed around a central strand.

22. The tyre according to claim 21, wherein each of said metallic cords comprises a central strand surrounded by six outer strands.

23. The tyre according to claim 21, wherein a twisting pitch in said central strand is greater than a twisting pitch in the outer strands.

24. The tyre according to claim 21, wherein each of said strands comprises three to seven filaments.

25. The tyre according to claim 21, wherein all the strands comprise a same number of filaments.

26. The tyre according to claim 21, wherein at least one of said strands comprises at least one filament having a diameter greater than a diameter of remaining filaments.

27. The tyre according to claim 26, wherein a diameter of the filaments of said central strand is greater than a diameter of the filaments of the outer strands.

28. The tyre according to claim 21, wherein the filaments in said strands are twisted according to a first twisting orientation, and wherein said strands are twisted to form said metallic cord according to a second orientation, equal to the first orientation.

29. The tyre according to claim 21, wherein said metallic cords in said at least one carcass ply are disposed substantially orthogonally to a circumferential direction of the tyre.

30. The tyre according to claim 21, wherein said belt structure comprises at least two radially superimposed main belt layers, wherein each of said at least two main belt layers comprises a second plurality of metallic cords disposed in a crossed orientation with respect to a circumferential direction of the tyre, wherein the metallic cords of a radially inner main belt layer are crossed with respect to the metallic cords of a radially outer main belt layer.

31. The tyre according to claim 30, wherein said belt structure comprises a radially outermost belt layer comprising a third plurality of metallic cords disposed in a crossed orientation with respect to the circumferential direction of the tyre.

32. The tyre according to claim 30, wherein said belt structure comprises at least one zero degree layer comprising a fourth plurality of metallic cords disposed substantially at a null angle with respect to the circumferential direction of the tyre.

33. The tyre according to claim 32, wherein said at least one zero degree layer comprises two strips located in axially external positions of said belt structure.

34. The tyre according to claim 32, wherein said at least one zero degree layer is radially superimposed with said radially outer main belt layer.

35. The tyre according to claim 21, capable of being adapted to fit on a rim having a diameter of less than 20 inches.

36. A rubberized layer comprising a plurality of metallic cords embedded in a rubber compound, wherein each of said metallic cords comprises a plurality of strands twisted according to a twisting orientation, wherein each strand of the plurality of strands comprises a plurality of filaments having a diameter between 0.06 and 0.15 mm twisted according to said twisting orientation, and wherein the plurality of strands is disposed so as to form a structure having a cross section in which a substantially circular layer of outer strands is disposed around a central strand.

37. The rubberized layer according to claim 36, wherein a thickness of said rubberized layer is between 1.2 mm and 2.5 mm.

38. The rubberized layer according to claim 36, wherein a density of said plurality of metallic cords in said rubberized layer is between 50 cords/dm and 120 cords/dm.

39. The rubberized layer according to claim 36, wherein said plurality of metallic cords is embedded in said rubber compound so as to alternate with portions comprising only rubber compound having substantially a same width between 0.15 mm and 1.4 mm.

40. A metallic cord comprising a plurality of strands twisted according to a twisting orientation, wherein each strand of the plurality of strands comprises a plurality of filaments having a diameter between 0.06 and 0.15 mm twisted according to said twisting orientation, and wherein the plurality of strands is disposed so as to form a structure having a cross section in which a substantially circular layer of outer strands is disposed around a central strand.
